(19) United States
(12) Patent Application Publication
(10) Pub. No.: US 2011/0067761 A1
(43) Pub. Date: Mar. 24, 2011

(54) Storage Tank Containment Apparatus

(76) Inventor: Jayson King, Corning (CA)

(21) Appl. No.: 12/877,485

(22) Filed: Sep. 8, 2010

(30) Foreign Application Priority Data
Sep. 8, 2009 (CA) 2,678,143

(51) Int. Cl. F17D 1/00; B65D 1/34

(52) U.S. Cl. 137/1; 137/312

(57) ABSTRACT

A secondary containment apparatus for storage tanks has a floor, and side walls sealed to the floor to form a containment structure configured to be placed on a transport vehicle for transport along a public road as a single unit so further assembly at the work site is not required. The floor and the side walls are configured to support the side walls in an upright orientation, and lifting lugs are configured for connection to a crane for lifting the apparatus. A wall port can be provided in a lower portion of the side wall to facilitate connection of the storage tank inside the structure to a conduit outside the structure.

### FIELD OF THE INVENTION

This invention is in the field of liquid storage equipment and in particular a containment apparatus for containing liquid that might leak from liquid storage tanks.

### BACKGROUND

Large liquid storage tanks are used in a variety of industries. For example in the petroleum industry, oil is pumped from underground reservoirs to the surface at oil well sites. The oil coming from the well site is commonly connected to a pipeline system and conveyed to a central storage location through the pipeline system. Where such a pipeline system is not available however, one or more large storage tanks are placed on the well site, and the oil is pumped into the tanks. Periodically a transport will remove oil from the tanks and haul it away.

Where the stored liquid, such as oil, poses an environmental hazard, the storage tanks must be located inside a containment structure that is configured to contain any liquid that might be spilled from the tank. Such containment structures typically include walls supported upright on the ground and extending around the tank, and an impervious liner made from plastic or the like that covers the ground and extends generally to the top of the inside surface of the walls, thereby forming a container. The area enclosed by the walls and the height of the walls are configured to provide sufficient volume to contain the required amount of liquid, which is usually regulated in the jurisdiction where it will be used, based on the number and capacity of the tanks being contained.

A typical containment structure is disclosed for example in Canadian Patent Number 2,362,105 to Mackie. A plurality of wall panels are connected end-to-end with corners as required to form an enclosure and the liner is laid on the ground and up over the top of the wall panels. Braces extend from the ground to the top of the wall outside the wall. The storage tanks are placed on the liner inside the enclosure.

In a typical oil well site then, a conduit extends along the ground from the oil well output to the wall, then up over the wall and down along the inside of the wall to the ground, and then along the ground to the tank where it is connected to a port in the wall of the tank, such that oil can flow from the well output into the tank. Valves are also provided to allow for connection of conduits to remove oil from the tanks.

Thus the typical containment structure is quite time consuming to erect. As well, the conduit needs to have a number of elbows to go up and over the wall, which increases the risk of leaks, and also increases the cost and the time to connect the oil well to the tank, and restricts flow to the tank, increasing the pressure required to push the oil to the tank. Going up and over the wall can also provide a liquid trap where liquid gathers in the conduit when idle, and which can be subject to freezing and disruption of flow to the tank.

### SUMMARY OF THE INVENTION

It is an object of the present invention to provide a containment apparatus for storage tanks that overcomes problems in the prior art.

The present invention provides, in a first embodiment, a secondary containment apparatus for storage tanks. The apparatus comprises a floor, and side walls extending upward from a perimeter of the floor, wherein the side walls are sealed to the floor to form a containment structure. The floor and the side walls are configured such that the side walls are supported in an upright orientation, and a plurality of lifting lugs are configured for connection to a crane for lifting the apparatus. The containment structure is configured to be placed on a transport vehicle for transport along a public road.

The present invention provides, in a second embodiment, a storage tank apparatus comprising a containment structure configured to be placed on a transport vehicle for transport along a public road. The containment structure comprises a rectangular floor and four side walls extending upward from a perimeter of the floor, wherein the side walls are welded to the floor and to adjacent sidewalls, and the floor and the side walls are configured such that the side walls are supported in an upright orientation. A plurality of lifting lugs are configured for connection to a crane for lifting the apparatus. First and second storage tanks are supported on the floor inside the containment structure, and each storage tank is connected by a conduit to an oil well production output.

The present invention provides, in a third embodiment, a method of providing secondary containment for at least one storage tank at a work site. The method comprises assembling a containment structure with a floor and side walls extending upward from a perimeter of the floor, sealing the side walls to the floor; supporting the side walls in an upright orientation; and attaching a plurality of lifting lugs to the containment structure. When the containment structure is assembled connecting an assembly site crane to the lifting lugs and lifting the containment structure on to a transport vehicle, disconnecting the assembly site crane, and transporting the containment structure along a public road to the work site; preparing a pad with a substantially level top surface in a desired location at the work site; connecting a work site crane to the lifting lugs and lifting the containment structure off the vehicle and placing the containment structure on the top surface of the pad; connecting the work site crane to the at least one storage tank and lifting the at least one storage tank over a top edge of the side walls of the containment structure and placing the at least one storage tank on the floor of the containment structure.

Thus the invention provides a one piece containment apparatus that can be transported as single unit to a work location and placed on the ground without further construction. Conveniently the apparatus is made from welded steel and the inside is coated with epoxy or the like to protect the steel. The apparatus includes required bracing and support for transport. Braces are located inside the containment structure such that the braces do not extend outside the walls so that the transport width can be kept to a minimum.

To facilitate connection to a supply conduit, such as the output from an oil well, threaded or flanged ports can be provided through lower portions of the walls so that the outer supply conduit from the well output can run along the ground and be sealed to the outside of the port. Then the inner supply conduit from the tank can be sealed to the inside of the port, such that the supply conduit extends through the wall instead of over the wall, making a simpler connection, with reduced pressure loss and reduced risk that liquid will be trapped in the supply conduit. A plurality of ports can be provided to accommodate more than one tank, or to provide increased options for connecting to the supply conduit.

The one-piece construction of the present invention reduces the time and labor required to set up the containment apparatus in the desired working location. The port through the wall allows for convenient connection of a conduit to the tank inside the containment apparatus. The present invention can be used wherever contained storage of materials other work sites such as oil wells, mines, and like industries.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic perspective view of an embodiment of a containment apparatus of the present invention;

FIG. 2 is schematic sectional view along lines 2-2 in FIG. 1;

FIG. 3 is a schematic top view of the embodiment of FIG. 1, with tanks installed inside the containment apparatus;

FIG. 4 is a schematic sectional view of a wall port of the embodiment of FIG. 1 connected to outer and inner supply conduits;

FIG. 5 is a schematic sectional view of an alternate wall port connected to outer and inner supply conduits;

FIGS. 6-8 schematically illustrate a method of the invention for providing secondary containment for storage tanks at a work site.

### DETAILED DESCRIPTION OF THE ILLUSTRATED EMBODIMENTS

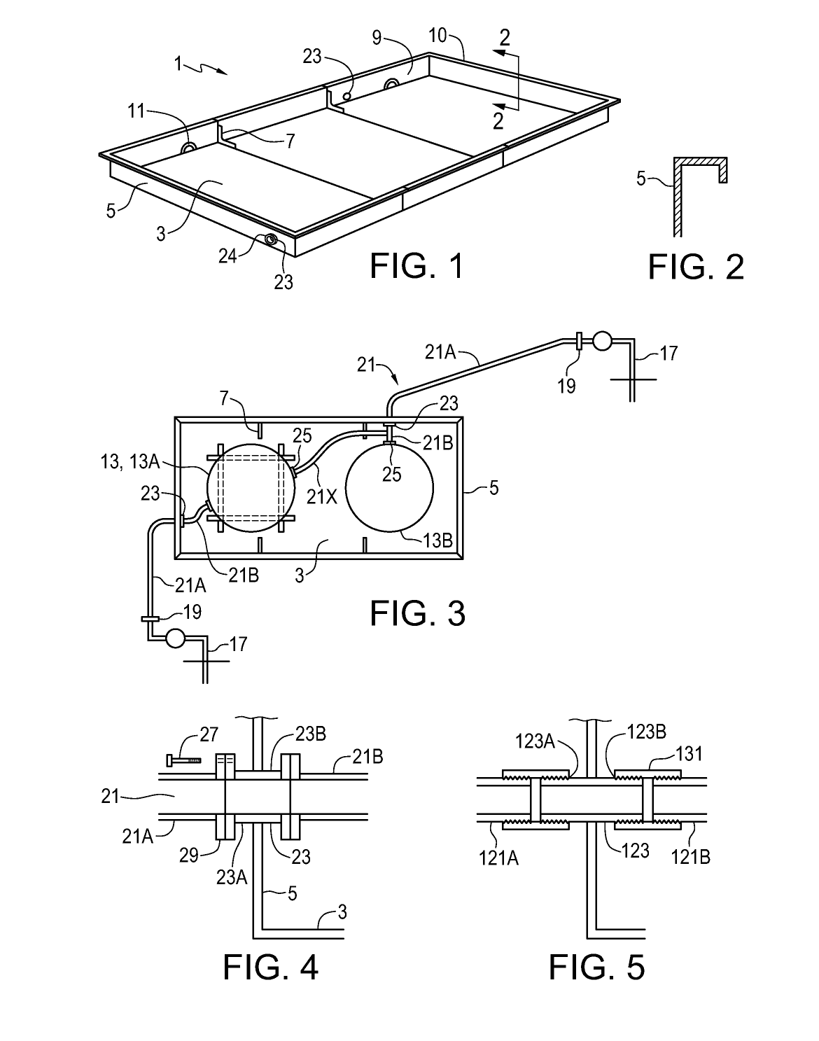

FIG. 1 schematically illustrates an embodiment of a one piece secondary containment apparatus 1 of the present invention. The apparatus 1 can be conveniently formed, for example, with a floor 3 and side walls 5 of steel, with the side walls 5 sealed to the floor 3 by welding to form a containment structure 10, and supported in an upright orientation. The floor 3 and side walls 5 can be constructed of sufficiently strong material to support the walls 5, or braces 7 can be provided. Inner surfaces 9 of the steel floor 3 and side walls 5 are coated with an epoxy or like protective material to seal and protect the steel material.

The braces 7 are attached inside the containment structure 10 to the floor 3 and side walls 5 as required to provide sufficient rigidity to the apparatus 1 to allow same to be loaded on a transport vehicle and transported on a on a public road, and to be substantially free standing at the working location. Locating the braces 7 inside the containment structure 10 allows the transport width to be about the same as the width of the containment structure 10. The top of the wall 5 can be formed as illustrated in FIG. 2 to provide increased strength and rigidity. A plurality of lifting lugs 11 are configured for connection to a crane for lifting the apparatus 1 onto and off of a vehicle.

The area enclosed by the walls 5 and the height of the walls 5 are calculated so that the apparatus 1 can contain all the liquid that is stored in the tanks that will be located in the apparatus 1. As an example and as schematically illustrated in FIG. 3, the floor 3 is rectangular with four side walls 5 with each side wall sealed to adjacent side walls 5 at each end thereof, as well as to the floor 3. Other shapes could be used as well that are suited to a particular application, for example circular, oval, square, or whatever is suitable in a given application.

In order to contain two common 400 barrel tanks, each about 12 feet in diameter, the containment structure 10 of the apparatus 1 could be about 20 feet wide, 40 feet long and have walls 5 that are about 3.5 feet high to satisfy capacity requirements in a particular jurisdiction. The weight is about 11,000 pounds which is readily carried by a truck or trailer.

The one piece apparatus 1 at about 20 feet wide can be transported in one piece on a trailer or the like along a public road in many jurisdictions, using pilot vehicles and warning lights as needed.

Once at the work site, such as an oil well site as schematically illustrated in FIG. 3, the apparatus can be placed on a pad, typically of compacted sand, crusher dust, or the like, with a substantially level top surface in a desired location at the work site. The bottom of the containment structure 10 is typically flat and supported on the surface of the pad, but it is contemplated that in some circumstances it will be desirable to provide skids or the like under the floor of the containment structure 10. Further construction is not required, and so work site set up time is minimal,

Some tanks come with a base 12 onto which the tank 13 is mounted but many tanks do not include such a base and the tank 13 is simply placed on the floor 3 of the containment structure 10 of the apparatus 1. Once the apparatus 1 is in place at the site, the tanks 13 are raised over the wall 5 of the apparatus 1 by a crane, and placed in the desired location on the floor 3 of the apparatus 1, or on the base provided. This crane can be used to both place the apparatus 1 on the ground, and then place the tanks 13 inside the apparatus 1. FIG. 3 shows one tank 13A located on a base, and the other tank 13B resting on the floor 3. Typically bridge planks will be laid on the floor 3 to protect the floor, and the tanks 13 will be placed on top of the bridge planks.

At the oil well site in FIG. 3, as an example of an industry where the invention can be used, there are shown two separate oil wells 17, each with an output 19. To facilitate connection of supply conduits 21 from the outputs 19 to the tanks 13, wall ports 23 are provided through lower portions of the walls 5 adapted at outer and inner sides 23A, 23B thereof for connection to a conduit. Each outer supply conduit 21A, which lies outside the containment structure 10 of the apparatus 1, is connected at one end to the well output 19 and runs along the ground or supported somewhat above the ground to the opposite end which is connected and sealed to the outer side 23A of the wall port 23.

The inner supply conduit 21B, which lies inside the apparatus 1, is connected at one end to a tank port 25 of the tank 19 and runs along the ground or supported somewhat above the ground to the opposite end which is connected and sealed to the inner side 23B of the port 23. Thus the resulting complete supply conduit 21 comprises outer and inner supply conduits 21A, 21B passing through the wall 5 just above the ground, with the resulting reduced complexity of piping. It is also contemplated that in some situations it may also be desired to provide wall ports 23 in higher portions of the wall 5.

A number of wall ports 23 can be provided at various locations along the side walls 5 to provide increased options and allow for other connections to the tanks through the wall, or for greater versatility in placing the tanks 13 by providing optional routes for the supply conduit 21. These additional wall ports 23 can be sealed off with a cap 24 or the like when not in use to seal the wall 5.

The wall port 23 can be flanged as schematically illustrated in FIG. 4 where the outer and inner conduits 21A, 21B are attached to the corresponding outer and inner sides 23A, 23B of the wall port 23, by connecting bolts 27 through holes in the flanges 29 as is known in the art. The resulting complete supply conduit 21 passes through the wall 5 just above the floor 3.

FIG. 5 schematically illustrates a threaded wall port 123 where threaded outer and inner conduits 121A, 121B are connected to threaded outer and inner sides 123A, 123B of the wall port 123 by a threaded coupler 131. It is contemplated that other connection means known in the art could also be used to connect the supply conduits to the wall port.

There may also be only a single oil well producing at a work site, in which case it may be desirable to connect the single production output 19 to both storage tanks 13. As schematically illustrated in FIG. 3, inner conduit 21X from a tank port 25 on tank 13A can be connected in a T-junction with the inner conduit 21B from tank 13B such that both tanks 13A, 13B are connected to the inner side of the same wall port 23, and thus to a single oil well production output such that the output fluid will be stored in both tanks 13.

The present invention thus provides a method of providing secondary containment for storage tanks 13 at a work site. The method comprises assembling a containment structure 10 with a floor 3 and side walls 5 extending upward from a perimeter of the floor 3, and sealing the side walls 5 to the floor 5. A plurality of braces 7 are attached to the floor 3 and the side walls 5 inside the containment structure 10 and are configured to support the side walls 5 in an upright orientation.

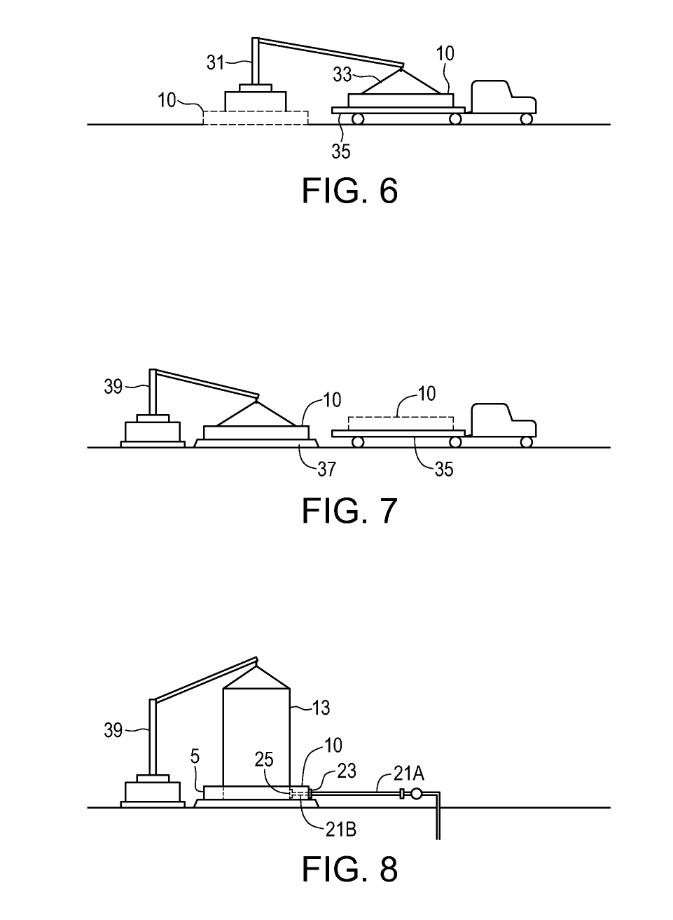

A plurality of lifting lugs 11 are attached to the containment structure 10, and an assembly site crane 31 is connected to the lifting lugs 11 by cables 33 and the crane 31 lifts the containment structure 10 off the ground and onto a transport trailer 35, as schematically illustrated in FIG. 6. The assembly site crane 31 is disconnected, and the containment structure 10 is transported along public roads to the work site where a pad 37 with a substantially level top surface has been prepared in a desired location at the work site as schematically illustrated in FIG. 7.

At the work site, a work site crane 39 is connected to the lifting lugs 11 and lifts the containment structure 10 off the trailer 35 and places the containment structure 10 on the top surface of the pad 37 such that the containment structure 10 rests on the top surface of the pad 37. Once the containment structure 10 is in place, the work site crane is connected to a storage tank 13 and lifts the storage tank 13 over a top edge of the side walls 5 of the containment structure 10 and places the storage tank 13 on the floor of the containment structure 10 as schematically illustrated in FIG. 8.

As described above, outer conduit 21A is connected to a tank port 25 on the storage tank by providing a wall port 23 extending through a lower portion of a side wall 5 and connecting the outer conduit 21A to an outer side of the wall port 23, and connecting an inner conduit 21B from an inner side of the wall port 23 to the tank port 25.

The present invention provides a significant time and labor advantage over prior art storage tank containment systems where containment walls must be erected at the work site and braced in an upright orientation and then a liner placed over the ground and up the walls. The present one piece containment structure can be loaded on a trailer or truck and hauled to a prepared pad and simply lifted off the trailer onto the pad. Generally a crane will be used to move the storage tanks and so will be available to place the containment structure. Plumbing the storage tanks to an external supply is facilitated by providing a wall port through a lower portion of the wall so the conduits do not have to bend up and over the wall as in the prior art.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A secondary containment apparatus for storage tanks, the apparatus comprising:
a floor, and side walls extending upward from a perimeter of the floor, wherein the side walls are sealed to the floor to form a containment structure;
wherein the floor and the side walls are configured such that the side walls are supported in an upright orientation; and
a plurality of lifting lugs configured for connection to a crane for lifting the apparatus;
wherein the containment structure is configured to be placed on a transport vehicle for transport along a public road.

2. The apparatus of claim 1 further comprising a wall port extending through a lower portion of a side wall, the wall port adapted at inner and outer sides thereof for connection to a conduit.

3. The apparatus of claim 2 wherein at least one side of the wall port is adapted for connection of a conduit by one of a threaded connection and a flanged connection.

4. The apparatus of claim 2 comprising a plurality of wall ports extending through lower portions of the side walls.

5. The apparatus of claim 1 comprising a plurality of braces attached to the floor and the side walls inside the containment structure and configured to support the side walls in an upright orientation.

6. The apparatus of claim 1 wherein the floor is rectangular with four side walls and wherein each side wall is sealed to adjacent side walls at each end thereof.

7. The apparatus of claim 6 wherein the containment structure is configured such that two 400 barrel oil storage tanks can be placed inside the containment structure, and such that the containment structure provides secondary containment for the two 400 barrel oil storage tanks.

8. The apparatus of claim 1 wherein the floor and side walls of the containment structure are steel and wherein the side walls are sealed to the floor by welding, and wherein inner surfaces of the steel floor and side walls are coated with a protective material.

9. A storage tank apparatus comprising:
a containment structure configured to be placed on a transport vehicle for transport along a public road, the containment structure comprising:
a rectangular floor and four side walls extending upward from a perimeter of the floor, wherein the side walls are welded to the floor and to adjacent sidewalls, and the floor and the side walls are configured such that the side walls are supported in an upright orientation; and
a plurality of lifting lugs configured for connection to a crane for lifting the apparatus;
first and second storage tanks supported on the floor inside the containment structure, each storage tank connected by a conduit to an oil well production output.

10. The apparatus of claim 9 wherein the containment structure comprises a first wall port extending through a lower portion of a side wall, and wherein each storage tank is connected by an inner conduit to an inner side of the wall port and wherein the oil well production output is connected by an outer conduit to an outer side of the wall port.

11. The apparatus of claim 10 wherein at least one side of the first wall port is connected to one of the inner and outer conduits by one of a threaded connection and a flanged connection.

12. The apparatus of claim 10 wherein the containment structure comprises an idle second wall port extending through a lower portion of the side walls.

13. The apparatus of claim 9 wherein the floor and side walls of the containment structure are steel and wherein the side walls are sealed to the floor and to adjacent side walls by welding, and wherein inner surfaces of the steel floor and side walls are coated with a protective material.

14. The apparatus of claim 9 wherein the containment structure comprises a plurality of braces attached to the floor and the side walls inside the containment structure and configured to support the side walls in an upright orientation.

15. A method of providing secondary containment for at least one storage tank at a work site, the method comprising:
assembling a containment structure with a floor and side walls extending upward from a perimeter of the floor, and sealing the side walls to the floor;
supporting the side walls in an upright orientation; and
attaching a plurality of lifting lugs to the containment structure;
connecting an assembly site crane to the lifting lugs and lifting the containment structure on to a transport vehicle, disconnecting the assembly site crane, and transporting the containment structure along a public road to the work site;
preparing a pad with a substantially level top surface in a desired location at the work site;
connecting a work site crane to the lifting lugs and lifting the containment structure off the vehicle and placing the containment structure on the top surface of the pad;
connecting the work site crane to the at least one storage tank and lifting the at least one storage tank over a top edge of the side walls of the containment structure and placing the at least one storage tank on the floor of the containment structure.

16. The method of claim 15 comprising connecting an outer conduit to a tank port on the at least one storage tank by providing a wall port extending through a lower portion of a side wall, connecting the outer conduit to an outer side of the wall port, and connecting an inner conduit from an inner side of the wall port to the tank port.

17. The method of claim 16 comprising connecting the conduits to the wall port by one of a threaded connection and a flanged connection.

18. The method of claim 16 comprising providing a plurality of wall ports extending through lower portions of the side walls and sealing the inner and outer sides of wall ports that are not being used.

19. The method of claim 15 wherein the floor is rectangular with four side walls and wherein each side wall is sealed to adjacent side walls at each end thereof.

20. The method of claim 15 comprising supporting the side walls in an upright orientation by attaching a plurality of braces to the floor and the side walls inside the containment structure.
